(19) United States
(12) Patent Application Publication
(10) Pub. No.: US 2021/0308743 A1
(43) Pub. Date: Oct. 7, 2021

(54) METHOD FOR CONTROLLING FASTENING DEVICE AND FASTENING SYSTEM

(71) Applicant: MITSUBISHI HEAVY INDUSTRIES, LTD., Tokyo (JP)

(72) Inventors: Seisaku ODAN, Tokyo (JP); Michinobu TAKAHAGI, Tokyo (JP)

(21) Appl. No.: 17/267,671

(22) PCT Filed: Nov. 8, 2019
(86) PCT No.: PCT/JP2019/043919

§ 371 Date: Feb. 10, 2021

(30) Foreign Application Priority Data
Nov. 13, 2018 (JP) 2018-212884

(51) Int. Cl. B21J 15/28

(52) U.S. Cl. CPC B21J 15/28

(57) ABSTRACT

The device for controlling a fastening device causes an operation unit of the fastening device to execute a fastening operation step for performing a fastening operation on processing points that correspond to reference positions, the reference positions being respectively provided so as to correspond to the processing points and being provided in advance at positions such that, in consideration of a framework structure after the fastening operation is performed, interference with the framework structure does not occur. When an abnormality is detected or when information pertaining to interruption of the fastening operation is inputted, the control device causes the operation unit to move, on a path along reference positions corresponding to not-yet-processed processing points, to a reference position corresponding to a processing point that is at the end of the fastening operation range without executing the fastening operation step on not-yet-processed processing points.

### TECHNICAL FIELD

The present invention relates to a method for controlling a fastening device and a fastening system.

When a fastening operation is required in assembling general mechanical components, a technique by which through-holes are formed in advance in components used in assembly before the components are assembled and after the components are combined, fastening components (for example, bolts) are inserted into the through-holes formed in advance is adopted.

On the other hand, for example, when skeletons of an aircraft are assembled or the like, a technique by which the assembly of components is performed beforehand, a through-hole is formed in an assembly structure, and a fastening component (for example, bolts) is inserted into the through-hole formed is adopted. For example, an automatic drilling and riveting machine or the like is used as a fastening device that automatically drills a hole and fasten the components in the assembly structure.

For example, a fastening device which processes an outer shell of the aircraft includes an upper unit (for example, an upper anvil) that drills a hole and inserts a rivet from the surface of the outer shell, and a lower unit (for example, a lower anvil) that receives the thrust force of drilling from a back side of the outer shell and crimps a fastening component (for example, a rivet or the like) inserted.

Here, the assembly structure often has protrusions of various sizes or has components protruding, and generally has a complicated shape in many cases. Then, the upper unit and the lower unit of the fastening device are required to be finely controlled according to the complicated shape so as not to interfere (contact) with the protrusions or the like having such a shape.

For example, PTL 1 discloses a technique of creating an operation path including an approach path along which an operation tool is moved to a start point of a continuous operation range from an approach position where there is no interference with an assembly structure, and a retraction path along which the operation tool is moved from an end of the continuous operation range to a retraction position where there occurs no interference, and controlling an industrial robot based on the operation path.

### CITATION LIST

### Patent Literature

[PTL 1] Japanese Patent No. 3037664

### SUMMARY OF INVENTION

### Technical Problem

In the fastening device described above, when it is difficult to continue to perform processing due to various obstructive factors during processing, the upper unit and the lower unit are required to be retracted without coming into contact with the outer shell or the skeletons. Then, in this case, as in an offset anvil which is one example of the lower unit, in the fastening device that continues to perform multi-axis movement until the fastening device deeply enters an internal skeleton to reach a processing point, when an abnormality occurs, the fastening device is required to be retracted from the position at the occurrence of the abnormality by manual operation, so that the burden on an operator is increased and a large amount of time is required.

The present invention has been made in view of such circumstances, and an object of the present invention is to provide a method for controlling a fastening device and a fastening system capable of promptly and easily retracting the fastening device when a fastening operation has to be interrupted due to the occurrence of an abnormality or the like during fastening operation.

### Solution to Problem

According to a first aspect of the present invention, there is provided a method for controlling a fastening device that performs a fastening operation for a plurality of processing points set in a fastening operation range of an assembly structure in which a plurality of components are assembled, the method including: an approach step of moving an operation portion of the fastening device from an approach position set in advance to a reference position corresponding to a processing point which is a start point of the fastening operation range, while avoiding contact with the assembly structure; a fastening operation step of performing, from a reference position that is provided to correspond to the processing point and is provided in advance at a position where there occurs no interference with the assembly structure while assuming the assembly structure after the fastening operation is performed, the fastening operation for the processing point corresponding to the reference position; a movement step of moving the operation portion to a reference position corresponding to a next processing point whenever the fastening operation step is ended; and an operation interruption step of moving the operation portion to a reference position corresponding to a processing point which is an end of the fastening operation range, along a path that traces reference positions corresponding to processing points for which processing is not performed, without performing the fastening operation step at the processing points for which processing is not performed, when an abnormality is detected or when information regarding interruption of the fastening operation is input.

According to the method for controlling a fastening device, the approach step is performed, so that the operation portion is moved from the approach position set in advance to the reference position corresponding to the processing point (start processing point) which is the start point of the fastening operation range, while avoiding interference with the assembly structure. Then, the fastening operation step is performed for the processing point (start processing point) corresponding to the reference position after the movement, so that the fastening operation is performed for the start processing point. Then, whenever the fastening operation step is ended, the movement step of moving the operation portion to the reference position corresponding to the next processing point is performed, so that the operation portion is moved to the reference position corresponding to the next processing point, and the fastening operation step is performed for the processing point corresponding to the reference position, so that the fastening operation is performed for the processing point. Then, the movement step and the fastening operation step are repeatedly performed to execute the fastening operation for all the processing points. In such a series of the fastening operations, when an abnormality is detected or when information regarding interruption of the fastening operation is input, the fastening operation step is not performed at the processing points for which processing is not performed at that time, and the operation portion is moved along the path that traces the reference positions corresponding to the processing points for which processing is not performed. Since the reference positions are set in advance to the positions where there is no interference with the assembly structure, the operation portion of the fastening device can be safely and easily moved to the reference position corresponding to the end of the fastening operation range, while avoiding contact with the assembly structure. In addition, since control by manual operation is not required, the burden on an operator can be reduced.

In the method for controlling a fastening device, a retraction step of retracting the operation portion to a retraction position set in advance from the reference position corresponding to the processing point which is the end of the fastening operation range, while avoiding contact with the assembly structure, may be performed after the operation interruption step.

According to the method for controlling a fastening device, since the retraction step is performed after the operation interruption step, when an abnormality occurs or when information regarding interruption of the fastening operation is input, the operation portion can be safely and promptly retracted to the retraction position.

The method for controlling a fastening device may further include a fastening operation restarting step of performing the approach step for the fastening operation range in which the fastening operation is interrupted, when an input operation for restart of the operation is performed to restart the fastening operation after the operation interruption step is performed, thereafter, moving the operation portion such that the reference positions corresponding to the processing points for which processing is already performed are sequentially traced, and restarting the fastening operation step for the processing point for which processing is not performed, when the operation portion is moved to the reference position corresponding to the processing point for which processing is not performed.

According to the method for controlling a fastening device, when the input operation for restart of the operation is performed to restart the fastening operation after the operation interruption step is performed, the approach step is performed, so that the operation portion is moved to the reference position corresponding to the processing point which is the start point of the fastening operation range in which the fastening operation is interrupted, while avoiding interference with the assembly structure. Then, the reference positions corresponding to the processing points for which the fastening operation is already performed are sequentially traced from the reference position, so that the operation portion is moved to the reference position corresponding to the processing point for which processing is not performed. Then, when the operation portion is moved to the reference position corresponding to the processing point for which processing is not performed, the fastening operation step is restarted for the processing point for which processing is not performed, so that the fastening operation can be sequentially executed for the processing points for which processing is not performed.

In this case, the reference positions are provided in advance at the positions where there is no interference (contact) with the assembly structure, while assuming the assembly structure after the fastening operation is performed. Therefore, even when the operation portion is moved to the reference position corresponding to the processing point for which processing is not performed, while tracing the reference positions corresponding to the processing points for which processing is already performed, the operation portion can be easily moved to the reference position corresponding to the processing point for which processing is not performed, while avoiding interference with the assembly structure. Since control by manual operation is not required, the burden on operator can be reduced.

According to a second aspect of the present invention, there is provided a fastening system including: a fastening device including the operation portion; and a control device that controls the operation portion by using the method for controlling the operation portion described above.

### Advantageous Effects of Invention

The present invention exhibits an effect of being able to promptly and easily retract the operation portion of the fastening device when the fastening operation has to be interrupted due to the occurrence of an abnormality or the like during fastening operation.

### BRIEF DESCRIPTION OF DRAWINGS

FIG. 1 is an overall system diagram illustrating an overall configuration of a fastening system according to one embodiment of the present invention.

FIG. 2 is a schematic configuration view illustrating a schematic configuration of a second unit in a fastening device according to one embodiment of the present invention.

FIG. 3 is a diagram illustrating one example of a hardware configuration of a control device according to one embodiment of the present invention.

FIG. 4 is a flowchart illustrating a procedure of a fastening operation step to be performed by the fastening device according to one embodiment of the present invention.

FIG. 5 is a view schematically illustrating a state of the second unit in each step to be performed according to the flowchart illustrated in FIG. 4.

FIG. 6 is a view schematically illustrating a state of the second unit in each step to be performed according to the flowchart illustrated in FIG. 4.

FIG. 7 is a view schematically illustrating a state of the second unit in each step to be performed according to the flowchart illustrated in FIG. 4.

FIG. 8 is a view illustrating a state of an assembly structure after the fastening operation step is performed according to one embodiment of the present invention is performed.

FIG. 9 is a view schematically illustrating a positional relationship between processing points and reference positions according to one embodiment of the present invention.

FIG. 10 is a view illustrating one example of a positional relationship between the assembly structure and the reference position after the fastening operation step is performed according to one embodiment of the present invention is performed.

FIG. 11 is a flowchart illustrating one example of a procedure of a method for controlling the second unit of the fastening device in a normal state.

FIG. 12 is a description view for describing a movement path of an operation portion in the method for controlling the second unit according to one embodiment of the present invention.

FIG. 13 is a view for describing a movement path of the operation portion when a fastening operation is continuously performed in a plurality of fastening operation ranges in the method for controlling the second unit according to one embodiment of the present invention.

FIG. 14 is a flowchart illustrating a procedure of an operation interruption step according to one embodiment of the present invention.

FIG. 15 is a view for describing a movement path of the operation portion in the operation interruption step according to one embodiment of the present invention.

FIG. 16 is a view for describing a movement path of the operation portion in the operation interruption step according to one embodiment of the present invention.

FIG. 17 is a flowchart illustrating a procedure of a fastening operation restarting step according to one embodiment of the present invention.

FIG. 18 is a view for describing a movement path of the operation portion in the fastening operation restarting step according to one embodiment of the present invention.

FIG. 19 is a view for describing a movement path of the operation portion in the fastening operation restarting step according to one embodiment of the present invention.

### DESCRIPTION OF EMBODIMENTS

Hereinafter, a method for controlling a fastening device and a fastening system according to one embodiment of the present invention will be described with reference to the drawings.

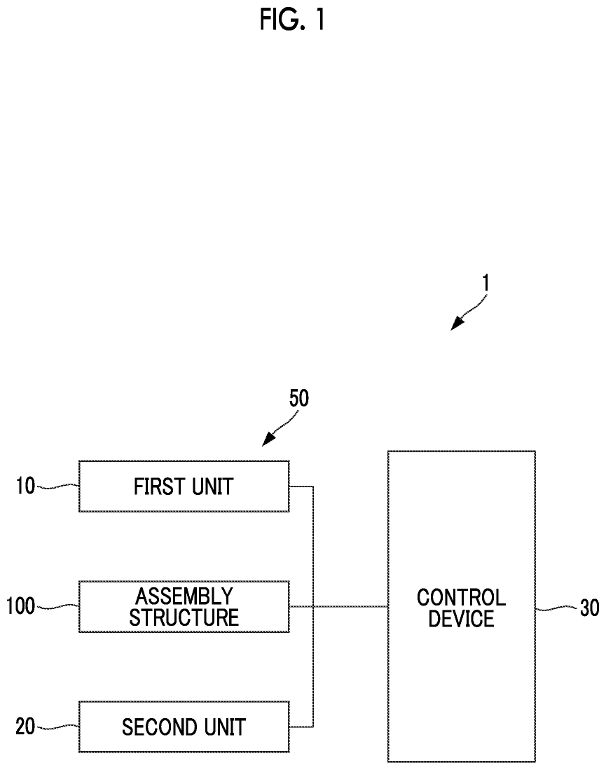

FIG. 1 is an overall system diagram illustrating an overall configuration of a fastening system 1 according to one embodiment of the present invention. As illustrated in FIG. 1, the fastening system 1 according to the present embodiment includes a fastening device 50 and a control device 30 that controls the fastening device 50, as main components.

The fastening device 50 according to the present embodiment is a device that forms a through-hole in an assembly structure 100 in which a plurality of components are assembled, and automatically fastens a fastening component (for example, a bolt, a rivet, and the like) to the formed through-hole.

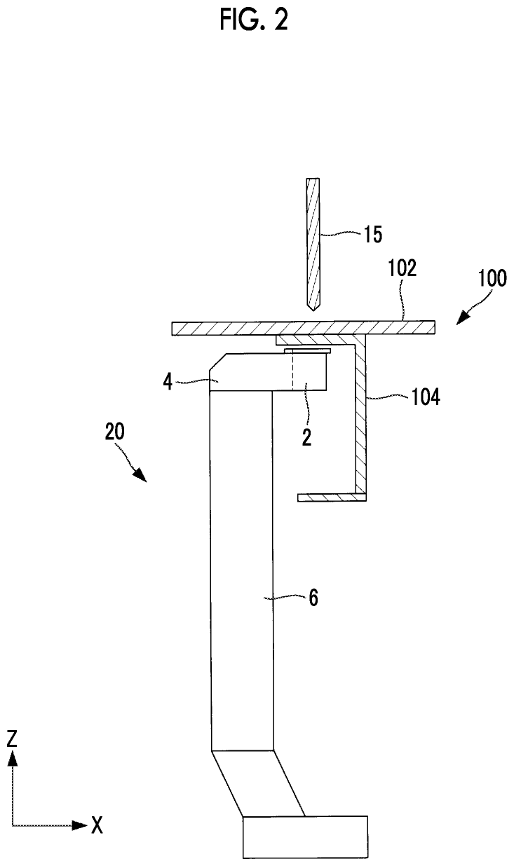

In the present embodiment, for example, as illustrated in FIG. 2, the assembly structure 100 is a structure in which a second component 104 is attached to a first component 102. An outer shell (skin) of an aircraft is provided as one example of the first component 102, and a stringer is provided as one example of the second component 104.

The fastening device 50 includes, for example, a first unit 10 and a second unit 20 that are installed on both sides to interpose the assembly structure 100 therebetween.

FIG. 2 is a schematic configuration view illustrating a schematic configuration of the second unit 20 of the fastening device 50 according to the present embodiment. As illustrated in FIG. 2, in the present embodiment, the first unit (not illustrated) is installed above the assembly structure 100 and the second unit 20 is installed below; however, a disposition direction of the first unit and the second unit 20 is not limited to this example. In FIG. 2, for convenience of description, an upward and downward direction is defined as a Z-axis direction, a horizontal direction is defined as an X-axis direction, a depth direction (for example, a direction perpendicular to the drawing sheet) is defined as an Y-axis direction, and hereinafter, a dispositional relationship is defined based on the Cartesian coordinate system.

The first unit 10 (refer to FIG. 1) is an industrial robot that performs a drilling operation with a drill 15 and an operation of inserting a fastening component such as a rivet from above the assembly structure 100, and the second unit 20 is an industrial robot that supports the thrust force of the assembly structure 100 from below, which is applied by drilling performed by the first unit 10, and crimps the inserted fastening component.

The second unit 20 includes an operation portion 2 that supports the thrust force applied to the assembly structure 100 and performs a fastening operation such as crimping the inserted rivet, an arm 4 at the tip of which the operation portion 2 is provided, a cylinder portion 6 that supports the arm 4, and the like. Known industrial robots can be appropriately adopted as the first unit 10 and the second unit 20, and examples of the industrial robots include a Cartesian robot, a Cartesian multi-axis robot, and a vertical articulated robot, and the like. When the first unit 10 and the second unit 20 are realized by vertical articulated robots, the operation portion 2 may be an end effector. In addition to an attachable and detachable example such as the end effector, the operation portion 2 and the arm 4 may be integrally formed and may be configured to move integrally. Regarding the shape of the first unit 10 and even the operation portion 2, an appropriate shape can be selected and adopted according to operation content.

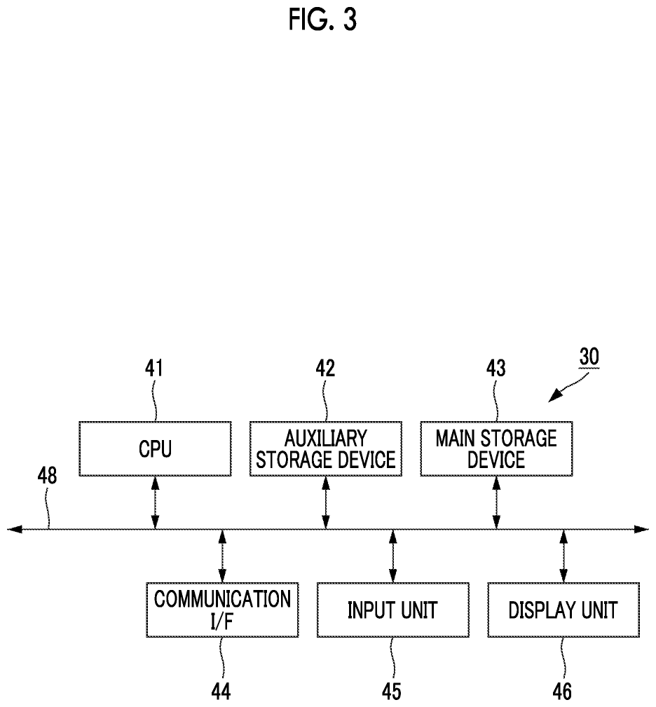

As illustrated in FIG. 3, the control device 30 includes, for example, a CPU 41, an auxiliary storage device 42 that stores programs to be carried out by the CPU 41, a main storage device 43 that functions as a work region when each of the programs is carried out, a communication interface (communication I/F) 44 that exchanges information with the first unit 10 or the second unit 20, an input unit 45 with which an operator performs an input operation, a display unit 46 that displays data, and the like. These parts are connected via, for example, a bus 48. Examples of the auxiliary storage device 42 include a magnetic disk, a magneto-optical disk, a semiconductor memory, and the like.

A processing procedure for realizing each step to be described later is stored in the auxiliary storage device 42 in the form of a program, and the CPU 41 reads the program into the main storage device 43 to execute information processing and arithmetic processing, so that various steps to be described later are realized.

A form in which the program is installed in a ROM or another storage medium in advance, a form in which the program is provided in a state where the program is stored in a computer-readable storage medium, a form in which the program is distributed via wired or wireless communication means, or the like may be applied.

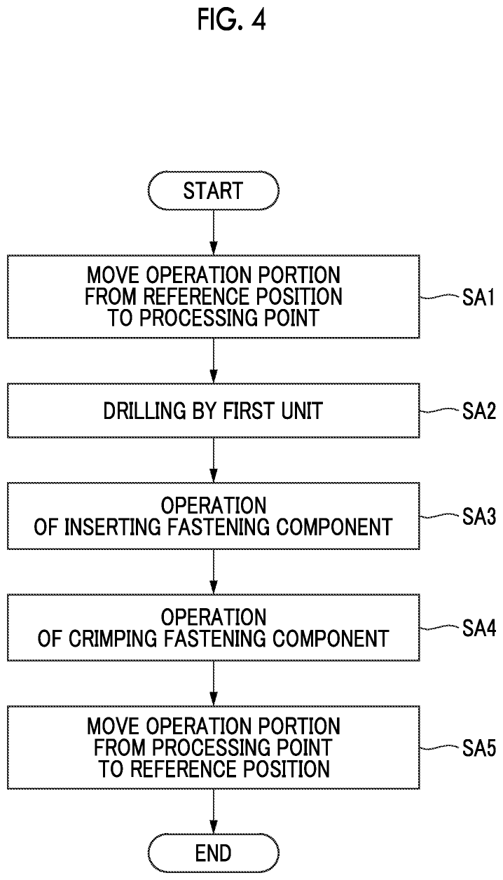

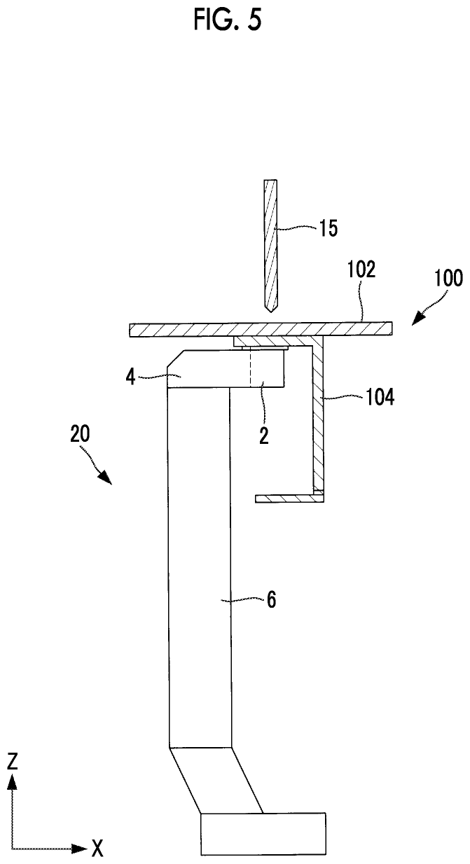

FIG. 4 is a flowchart illustrating a procedure of a fastening operation step to be performed by the fastening device 50 according to the present embodiment, and FIGS. 5 to 7 are views schematically illustrating the states of the second unit 20 in each step to be performed according to the flowchart illustrated in FIG. 4. Details of a “processing point” and a “reference position” in the following description will be described later.

In the fastening operation step, first, the operation portion 2 of the second unit 20 is moved to a processing point from a reference position provided corresponding to the processing point of the assembly structure 100 (SA1). Accordingly, as illustrated in FIG. 5, the assembly structure 100 is supported from below by the operation portion 2.

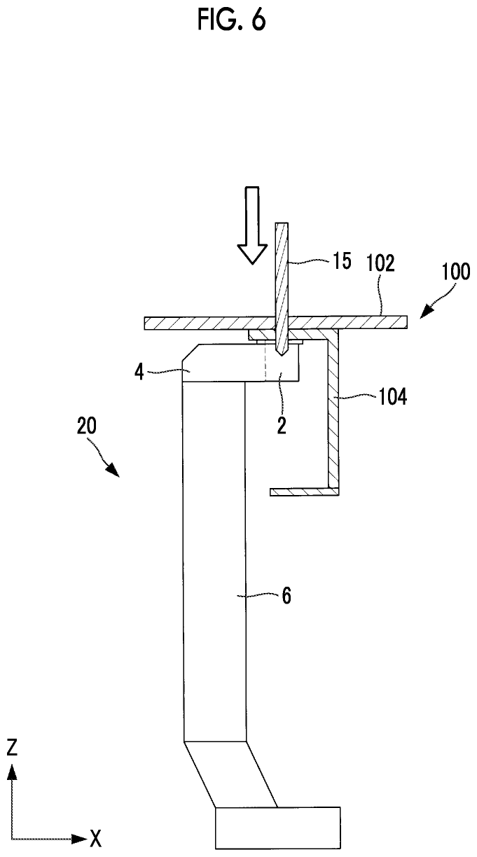

Subsequently, as illustrated in FIG. 6, the assembly structure 100 is drilled by the first unit 10 in a state where the assembly structure 100 is supported by the operation portion 2 of the second unit 20 (SA2). Specifically, the drill 15 of the first unit 10 is inserted into the processing point of the assembly structure 100 from above, so that a through-hole penetrating through the assembly structure 100 is formed.

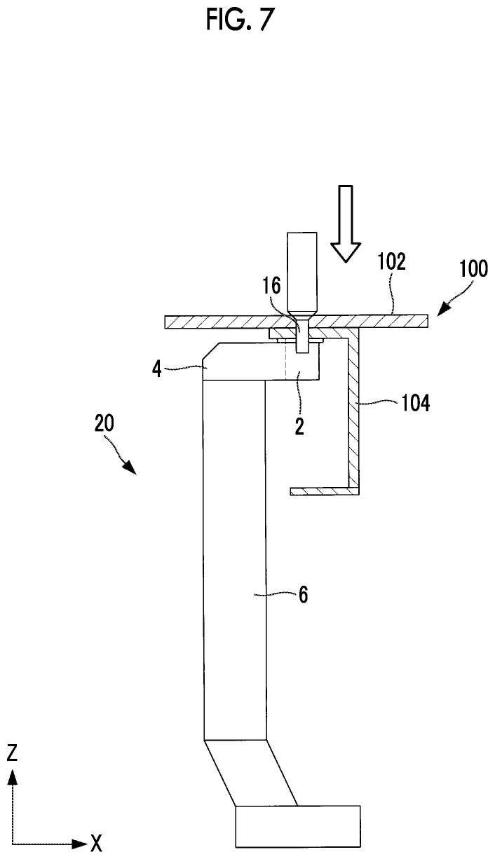

Subsequently, as illustrated in FIG. 7, an operation of inserting a fastening component is performed by an operation portion of the first unit 10 in a state where the assembly structure 100 is supported by the operation portion 2 of the second unit 20 (SA3). Accordingly, the fastening component (rivet) 16 is inserted into the through-hole.

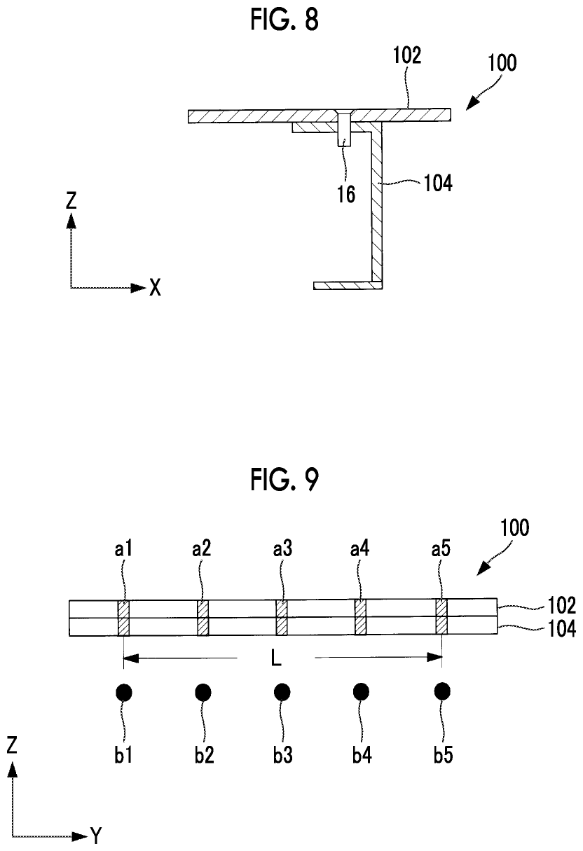

Subsequently, an operation of crimping the fastening component 16 is performed by the operation portion 2 of the second unit 20 (SA4). Accordingly, as illustrated in FIG. 8, the first component 102 and the second component 104 in the assembly structure 100 are fastened with the fastening component 16 at the processing point.

In such a manner, when the crimping operation is completed, the operation portion 2 of the second unit 20 is moved from the processing point to the reference position (SA5).

Next, the “processing point” and the “reference position” in the present embodiment will be described with reference to FIG. 9. FIG. 9 is a view schematically illustrating a positional relationship between processing points a1 to a5 and reference positions b1 to b5.

As illustrated in FIG. 9, a plurality of the processing points a1 to a5 are set at intervals in the Y-axis direction in a fastening operation range L set in the assembly structure 100. FIG. 9 illustrates a case where five processing points a1 to a5 are set for one fastening operation range L.

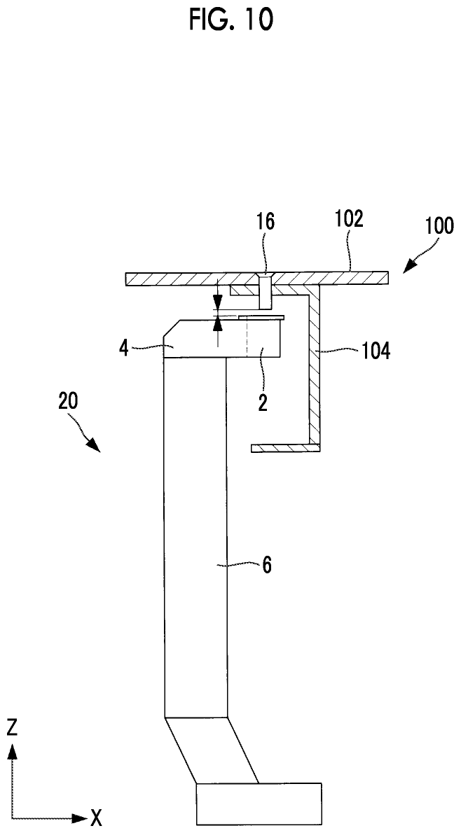

The reference positions b1 to b5 are provided to correspond to the processing points a1 to a5, respectively, and are provided at positions where there occurs no interference (contact) with the assembly structure 100. At this time, the assembly structure 100 is assumed to be an assembly structure after the fastening operation step is ended, namely, an assembly structure after the fastening components (for example, rivets) 16 are fastened. It is preferable that for example, as illustrated in FIG. 10, the reference positions b1 to b5 are provided at positions where there occurs no interference (contact) with the assembly structure 100 after the fastening components 16 are inserted and crimped and there is no interfering object on a path connecting the reference positions b1 to b5 adjacent to each other. Further, when the arrangement of the processing points a1 to a5 is defined on one axis (for example, an Y axis in the present embodiment) in the Cartesian coordinate system, it is preferable that the reference positions b1 to b5 are set such that the coordinate positions on other two axes (for example, an X axis and a Z axis in the present embodiment) are constant and only the coordinate positions on the one axis are changed. Since the reference positions b1 to b5 are set at such positions, the drive control of the operation portion 2 can be simplified.

Next, a method for controlling a fastening device according to the present embodiment will be described with reference to the drawings. In the following description, the control of the operation portion 2 of the second unit 20 will be mainly described.

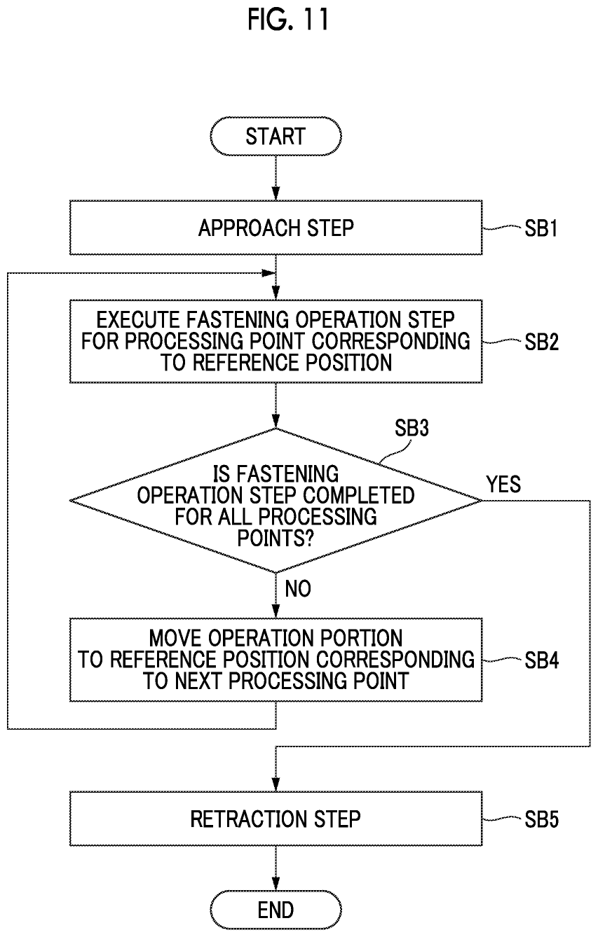

FIG. 11 is a flowchart illustrating one example of a procedure of a method for controlling the second unit 20 of the fastening device 50 in a normal state.

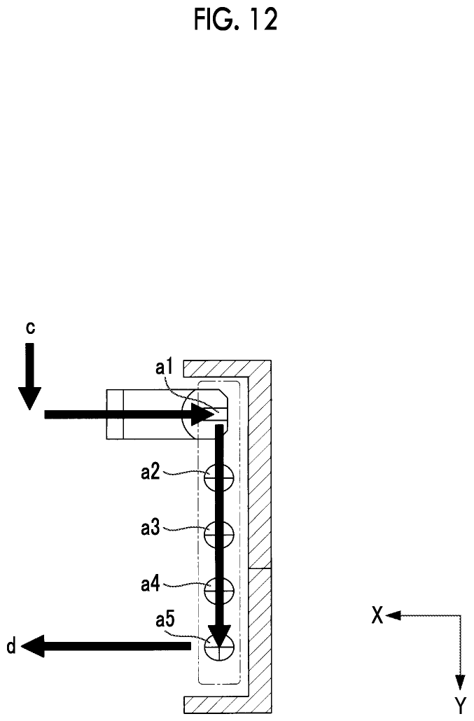

First, an approach step is performed (SB1). As illustrated in FIG. 12, the approach step is a step of moving the fastening device 50, more specifically, the operation portion 2 of the second unit 20 from an approach position c set in advance to the reference position b1 (refer to FIG. 9) corresponding to the processing point a1 which is a start point of the fastening operation range L, while avoiding contact with the assembly structure 100.

Accordingly, the operation portion 2 is moved to the reference position b1 (refer to FIG. 9) along a predetermined movement path set in advance while avoiding contact with the assembly structure 100.

Subsequently, the fastening operation step is to be performed for the processing point a1 corresponding to the reference position b1 (SB2). Accordingly, the fastening operation step illustrated in FIG. 4 is performed for the processing point a1 to execute drilling, an operation of inserting a fastening component, and an operation of crimping the fastening component, and thereafter, the operation portion 2 of the second unit 20 is returned to the reference position b1 (refer to FIG. 9).

Subsequently, it is determined whether or not the fastening operation step is completed for all the processing points (a1 to a5) (SB3). As a result, when the fastening operation step is not completed for all the processing points a1 to a5 (SB3: NO), a movement step of moving the operation portion 2 to the reference position b2 corresponding to the next processing point a2 is performed (SB4) and further, the fastening operation step is performed for the processing point a2 corresponding to the next reference position b2 (SB2). Then, the process after step SB2 is repeatedly performed to sequentially execute the fastening operation step also for the processing points a3 to a5.

Then, when the fastening operation step is ended for the processing point a5 which is an end of the fastening operation range L among a plurality of the processing points a1 to a5 (SB3: YES), a retraction step is performed (SB5). The retraction step is a step of retracting the operation portion 2 of the second unit 20 from the reference position b5 corresponding to the processing point a5 to a retraction position d (refer to FIG. 12) set in advance, while avoiding contact with the assembly structure 100. When the retraction step is performed, the operation portion 2 of the second unit 20 can be easily and smoothly moved from the reference position b5 to the retraction position d set in advance, while avoiding contact with the assembly structure 100.

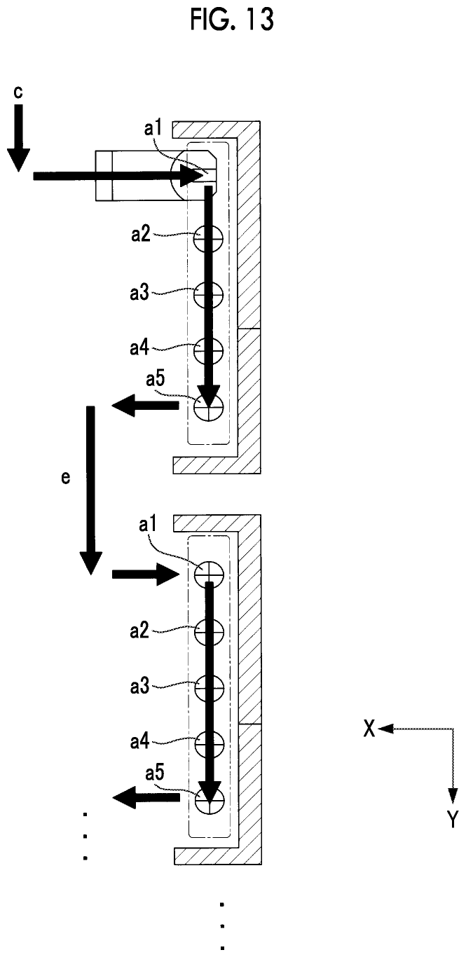

As illustrated in FIG. 13, when the fastening operation is continuously executed for a plurality of fastening operation ranges, a continuation step may be performed instead of the retraction step. For example, the continuation step is a step of moving the operation portion 2 from the reference position b5 corresponding to an end of a previous fastening operation range to the reference position b1 corresponding to a start point of the next fastening operation range, while avoiding interference with the assembly structure 100. Regarding a movement path e, an optimum path may be set in advance to be given as a program.

As described above, since the continuation step is performed instead of the retraction step, the fastening operation can be continuously performed for the plurality of processing points a1 to a5 set in a plurality of the fastening operation ranges L. Therefore, the efficiency of the fastening operation can be increased.

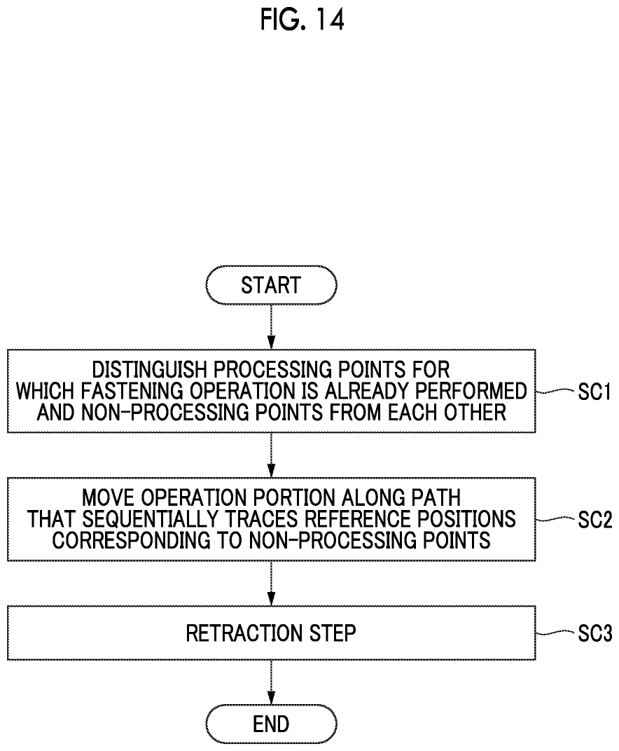

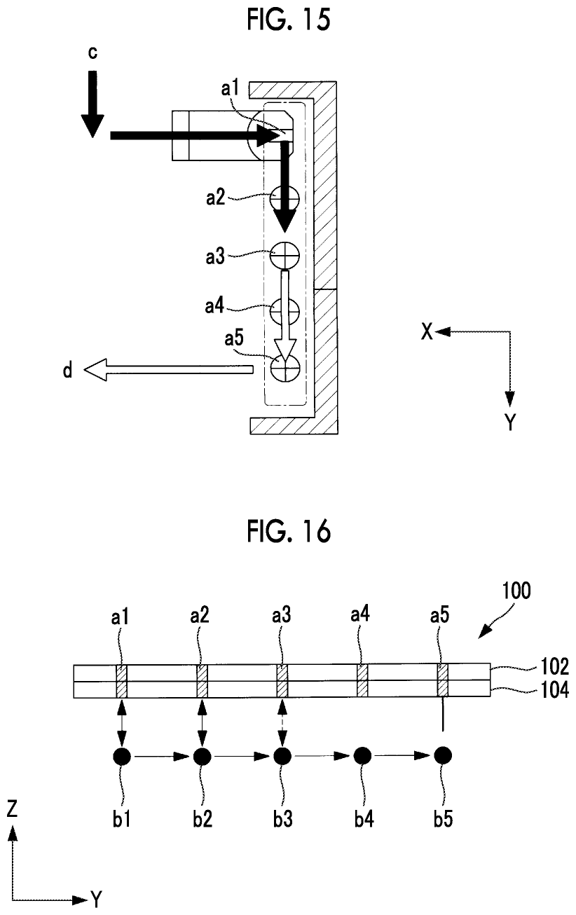

Next, an operation interruption step which is executed when an abnormality is detected or information regarding interruption of the fastening operation is input during execution of a series of the fastening operations described above will be described with reference to FIG. 14. FIG. 14 is a flowchart illustrating a procedure of the operation interruption step. FIGS. 15 and 16 are views for describing a movement path of the operation portion 2 in the operation interruption step.

Here, examples of when an abnormality is detected include when the drill is broken, when an incorrect fastening component is supplied, and the like. Examples of when information regarding interruption of the fastening operation is input include when the operator operates the input unit 45 to input a command for the interruption of the operation.

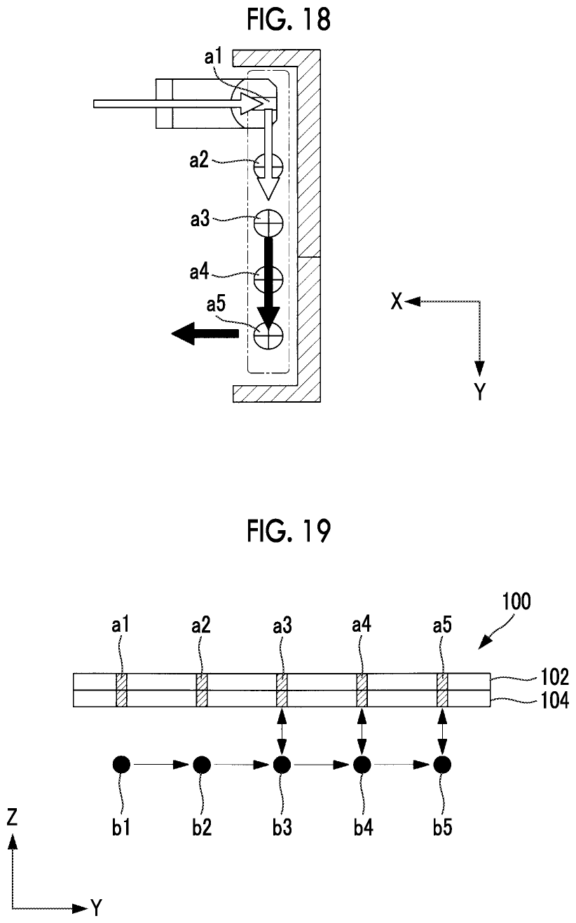

Hereinafter, for convenience of description, as illustrated in FIG. 15, a case where an abnormality occurs in a state where the fastening operation step is completed for the processing point a2 but the fastening operation step is not completed for the processing point a3 will be described as an example. In FIGS. 15 and 18, white arrows indicate that the fastening operation step is not completed for the processing points, and black arrows indicate that the fastening operation step is completed for the processing points.

In the operation interruption step, the processing points a1 and a2 for which the fastening operation is already performed and the non-processing points a3 to a5 for which the fastening operation is not yet completely ended are distinguished from each other (SC1). Then, a movement step of moving the operation portion 2 along a path which sequentially traces the reference positions b3 to b5 corresponding to the non-processing points a3 to a5 is performed (SC2). Accordingly, as illustrated in FIGS. 15 and 16, the fastening operation step illustrated in FIG. 4 is not executed for the non-processing points a3 to a5, and the operation portion 2 of the second unit 20 is moved to the reference position b5 which is the end of the fastening operation range, while tracing the reference positions b3 and b4. Regarding the path that traces each of the reference positions, such path data may be created in advance to be given to the control device 30, for example, as teaching data. The path may be common with the movement path used in the movement step in the method for controlling the second unit 20 described above, or may be set to a different path.

Subsequently, the retraction step described above is performed (SC3). Accordingly, the operation portion 2 of the second unit 20 can be retracted to the retraction position d set in advance from the reference position b5 corresponding to the processing point a5 which is the end, while avoiding contact with the assembly structure 100.

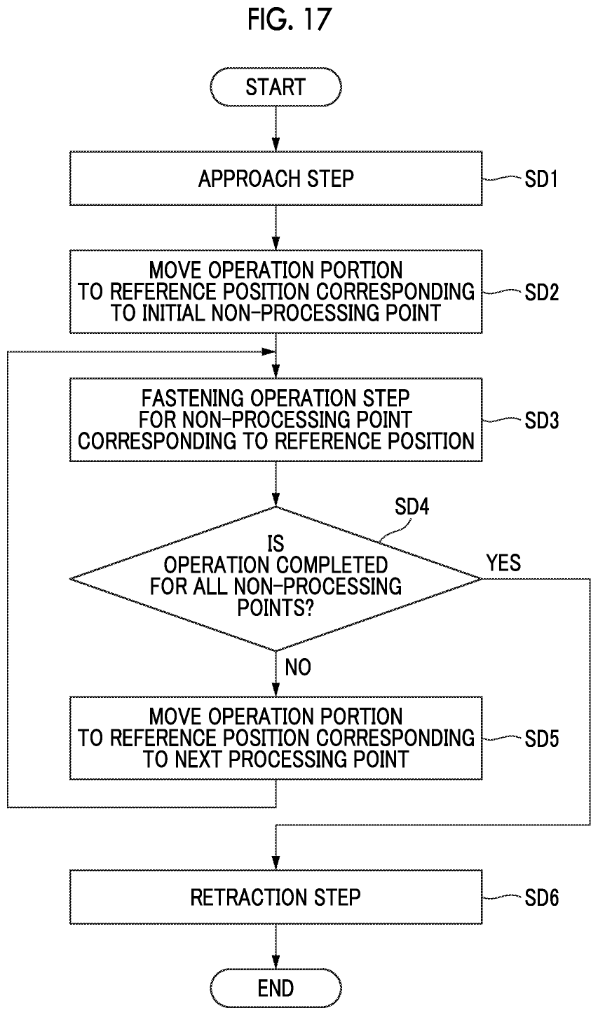

Subsequently, a fastening operation restarting step to be performed after the cause of the abnormality is removed will be described with reference to FIG. 17. FIG. 17 is a flowchart illustrating a procedure of the fastening operation restarting step. FIGS. 18 and 19 are views for describing a movement path of the operation portion 2 in the fastening operation restarting step.

The fastening operation restarting step is started, for example, when the operator performs an input operation for restart of the operation from the input unit 45.

In the fastening operation restarting step, first, an approach step is performed for the fastening operation range L in which the fastening operation is interrupted (SD1). Accordingly, the operation portion 2 of the second unit 20 is moved from an approach position to the reference position b1 corresponding to the start point of the fastening operation range L, while avoiding contact with the assembly structure 100.

Subsequently, a movement step of moving the operation portion 2 to the reference position b3 corresponding to the processing point a3 which is an initial processing point among the processing points a3 to a5 distinguished as non-processing points in the previous operation interruption step is performed (SD2). Accordingly, as illustrated in FIGS. 18 and 19, the operation portion 2 is moved to the reference position b3 through the reference positions b1 and b2.

At this time, since each of the reference positions b1 to b5 is provided at the position where there is no interference with the assembly structure 100 after the fastening operation step is performed, the operation portion 2 can be promptly moved to the reference position b3 without coming into contact with the assembly structure 100.

Subsequently, the fastening operation step is to be performed for the processing point a3 corresponding to the reference position b3 (SD3). Accordingly, the fastening operation step illustrated in FIG. 4 is performed for the processing point a3 to execute drilling, an operation of inserting a rivet, and an operation of crimping the rivet, and thereafter, the operation portion 2 is returned to the reference position b3.

Subsequently, it is determined whether or not the fastening operation step is completed for all the non-processing points (a3 to a5) (SD4). As a result, when the fastening operation step is not completed for all the non-processing points a3 to a5 (SD4: NO), a movement step of moving the operation portion 2 to the reference position b4 corresponding to the next processing point a4 is performed (SD5) and further, the fastening operation step is performed for the processing point a4 corresponding to the next reference position b4 is performed (SD3). Then, the process after step SD3 is repeatedly performed to sequentially execute the fastening operation step also for the processing points a3 to a5.

Then, when the fastening operation is ended for the processing point a5 located at the end of the fastening operation range (SD4: YES), a retraction step is performed (SD6). As described above, when the fastening operation is continuously performed also for the processing points a1 to a5 in the next fastening operation range, a continuation step may be performed instead of the retraction step.

As described above, according to the method for controlling a fastening device and the fastening system according to the present embodiment, in a series of the fastening operations, when an abnormality is detected or when information regarding interruption of the fastening operation is input, the fastening operation step is not performed at processing points for which processing is not performed at that time, and the operation portion 2 of the second unit 20 is moved along a path that traces reference positions corresponding to the processing points for which processing is not performed. Since the reference positions are set in advance to positions where there is no interference with the assembly structure 100, the operation portion 2 can be safely and easily moved to the reference position b5 corresponding to the processing point a5 located at the end of the fastening operation range, while avoiding contact with the assembly structure 100.

In addition, according to the method for controlling a fastening device and the fastening system according to the present embodiment, when an input operation for restart of the operation is performed to restart the fastening operation after the operation interruption step is performed, the approach step is performed, so that the operation portion 2 of the second unit 20 is moved to the reference position b1 corresponding to the start point of the fastening operation range, while avoiding interference with the assembly structure. Then, the reference positions b1 and b2 corresponding to the processing points a1 and a2 for which the fastening operation is already performed are sequentially traced from the reference position b1, so that the operation portion 2 of the second unit 20 can be easily moved to the reference position b3 corresponding to the processing point a3 for which processing is not performed, while avoiding interference (contact) with the assembly structure 100. Then, when the operation portion 2 is moved to the reference position b3 corresponding to the processing point a3 for which processing is not performed, the fastening operation step is restarted for the processing point a3 for which processing is not performed, so that the fastening operation can be sequentially executed for the processing points a3 to a5 for which processing is not performed.

The present invention has been described above using the embodiments; however, the technical scope of the present invention is not limited to the scope described in the embodiments. Various modifications or improvements can be made to the embodiments without departing from the concept of the invention, and the modifications or the improvements are also included in the technical scope of the present invention. The embodiments may be appropriately combined.

The flow of various steps in the method for controlling a fastening device described in the embodiments is also one example, and unnecessary steps may be deleted, new steps may be added, or the processing order may be changed without departing from the concept of the present invention.

### REFERENCE SIGNS LIST

1: Fastening system
2: Operation portion
4: Arm
6: Cylinder portion
10: First unit
15: Drill
16: Fastening component
20: Second unit
30: Control device
41: CPU
42: Auxiliary storage device
43: Main storage device
45: Input unit
46: Display unit
48: Bus
50: Fastening device
100: Assembly structure

1. A method for controlling a fastening device that performs a fastening operation for a plurality of processing points set in a fastening operation range of an assembly structure in which a plurality of components are assembled, the method comprising:
an approach step of moving an operation portion of the fastening device from an approach position set in advance to a reference position corresponding to a processing point which is a start point of the fastening operation range, while avoiding contact with the assembly structure;
a fastening operation step of performing, from a reference position that is provided to correspond to the processing point and is provided in advance at a position where there occurs no interference with the assembly structure while assuming the assembly structure after the fastening operation is performed, the fastening operation for the processing point corresponding to the reference position;
a movement step of moving the operation portion to a reference position corresponding to a next processing point whenever the fastening operation step is ended; and
an operation interruption step of moving the operation portion to a reference position corresponding to a processing point which is an end of the fastening operation range, along a path that traces reference positions corresponding to processing points for which processing is not performed, without performing the fastening operation step at the processing points for which processing is not performed, when an abnormality is detected or when information regarding interruption of the fastening operation is input.

2. The method for controlling a fastening device according to claim 1,
wherein a retraction step of retracting the operation portion to a retraction position set in advance from the reference position corresponding to the processing point which is the end of the fastening operation range, while avoiding contact with the assembly structure, is performed after the operation interruption step.

3. The method for controlling a fastening device according to claim 1, further comprising:
a fastening operation restarting step of performing the approach step for the fastening operation range in which the fastening operation is interrupted, when an input operation for restart of the operation is performed to restart the fastening operation after the operation interruption step is performed, thereafter, moving the operation portion such that the reference positions corresponding to the processing points for which processing is already performed are sequentially traced, and restarting the fastening operation step for the processing point for which processing is not performed, when the operation portion is moved to the reference position corresponding to the processing point for which processing is not performed.

4. A fastening system comprising:
a fastening device including the operation portion; and
a control device that controls the operation portion by using the method for controlling a fastening device according to claim 1.
